(19) United States
(12) Patent Application Publication
(10) Pub. No.: US 2026/0359904 A1
(43) Pub. Date: Nov. 12, 2026

(54) METHOD FOR SCHEDULING DISTRIBUTED COMPUTING POWER BASED ON DISTRIBUTED ENERGY SUPPLY

(71) Applicant: GUILIN UNIVERSITY OF ELECTRONIC TECHNOLOGY, GUILIN (CN)

(72) Inventors: PING ZHANG, GUILIN (CN); HONGGAO DENG, GUILIN (CN); LIN TAO, GUILIN (CN)

(21) Appl. No.: 19/728,276

(22) Filed: Jul. 1, 2026

Related U.S. Application Data
(63) Continuation of application No. PCT/CN2026/080757, filed on Mar. 2, 2026.

(30) Foreign Application Priority Data
Mar. 4, 2025 (CN) 202510248146.6

(51) Int. Cl. G06Q 50/06; G06Q 10/0631

(52) U.S. Cl. CPC G06Q 50/06; G06Q 10/06314

(57) ABSTRACT

A method for scheduling distributed computing power based on distributed energy supply includes obtaining energy information of a distributed energy system, obtaining status information of distributed computing nodes, and matching a target node based on the energy information, the status information, and a target task. The distributed energy includes one or more of solar energy, wind energy, and water energy. The energy information includes energy output information and energy reserve information. The distributed computing nodes include electronic devices having computing capability. The status information includes a computing capability and a task execution status of the distributed computing nodes. The target node is one of the distributed computing nodes having a highest matching degree with the target task. The method is configured to improve utilization efficiency of the distributed energy, reduce cost of obtaining computing power, and achieve collaborative optimization of the distributed energy and computing power.

### TECHNICAL FIELD

The present disclosure relates to fields of distributed energy supply and distributed computing power scheduling technologies, and in particular to a method for scheduling distributed computing power based on distributed energy supply.

### BACKGROUND

With an acceleration of digitalization, a global demand for computing power has exploded. However, conventional centralized computing power supply models, such as large data centers, face numerous issues. Specifically, the large data centers not only consume enormous amounts of energy and have high construction and operation costs, but also impose stringent requirements on geographical locations and infrastructure. Meanwhile, distributed energy sources, such as renewable energy, including solar, wind, and tidal energy, while widely distributed and environmentally friendly, face challenges in energy storage and consumption due to their intermittent and volatile characteristics. A large amount of distributed energy is wasted during production because the distributed energy is not utilized in a timely manner and effectively. Furthermore, a significant portion of the distributed energy is lost during an inversion process of converting the distributed energy from direct current (DC) to alternating current (AC), resulting in a substantial waste of the distributed energy.

The conventional centralized computing centers face problems such as high energy consumption (which requires AC-to-DC conversion), high construction costs, and geographical restrictions. Concurrently, although the distributed energy, such as solar energy, wind energy, and small-scale hydro power, is widely distributed across various regions. However, the distributed energy needs to be converted from DC to AC followed by transmission through a power grid. Utilization efficiency of the distributed energy needs further improvement, and there are difficulties in energy utilization. Therefore, how to effectively integrate distributed energy, supply power to distributed computing nodes, and form schedulable computing power resources has become an urgent technical problem to be solved to make up for the insufficiency of conventional centralized computing power.

In the prior art, the centralized computing centers generally rely on centralized power grid supplies, leading to problems such as high energy consumption, high carbon emissions, and high deployment costs in remote areas. Moreover, the distributed energy (e.g., wind energy, photovoltaics) is characterized by intermittent power supply, making it difficult to directly match requirements of high-stability computing power.

Therefore, there is an urgent need for a technical solution capable of deeply integrating the distributed energy with the computing power resources to achieve dynamic matching between the distributed energy and the computing power.

### SUMMARY

The present disclosure provides a method for scheduling distributed computing power based on distributed energy supply, so as to improve utilization efficiency of the distributed energy, reduce cost of obtaining computing power, and achieve collaborative optimization of the distributed energy and the distributed computing power.

The method comprises:
obtaining, through the distributed computing power scheduling platform, energy information of a distributed energy system, where the distributed energy comprises one or more of solar energy, wind energy, and water energy, and the energy information comprises energy output information and energy reserve information;
obtaining, through the distributed computing power scheduling platform, status information of distributed computing nodes, where each of the distributed computing nodes comprises an electronic device having computing capability, and the status information comprises a computing capability and a task execution status of each of the distributed computing nodes; and
matching, through the distributed computing power scheduling platform, a target node based on the energy information, the status information, and a target task, and allocating the target task to the target node for execution, where the target node is one of the distributed computing nodes having a highest matching degree with the target task within a current scheduling period.

The method is executed by a distributed computing power scheduling system. The distributed computing power scheduling system comprises the distributed computing power scheduling platform, the distributed energy system, and the distributed computing nodes. The distributed computing power scheduling platform is communicated with the distributed energy system and the distributed computing nodes.

In one optional embodiment, before obtaining, through the distributed computing power scheduling platform, the energy information of the distributed energy system, the method further comprises:
constructing, by the distributed computing power scheduling system, the distributed energy system based on the distributed energy and power storage units, where each of the power storage units comprises at least one of a battery power storage unit and a supercapacitor power storage unit; and
constructing, through the distributed computing power scheduling platform, the distributed computing nodes based on the electronic device having computing capability and a configuration strategy, where the configuration strategy at least comprises assigning an identifier and a permission to each of the distributed computing nodes.

In one optional embodiment, before obtaining, through the distributed computing power scheduling platform, the energy information of the distributed energy system, the method further comprises:
collecting the distributed energy through energy collection devices pre-configured in the distributed energy system; and
pre-processing, by the distributed energy system, the distributed energy collected, where the pre-processing comprises at least one of voltage adjustment, frequency conversion, and rectification filtering.

In one optional embodiment, the matching, through the distributed computing power scheduling platform, the target node based on the energy information, the status information, and the target task comprises:
extracting, through the distributed computing power scheduling platform, task information of the target task, where the task information at least comprises energy consumption, computational complexity, and time constraints; and
dynamically allocating, through the distributed computing power scheduling platform, the target task to the target node through a multi-objective scheduling algorithm according to the status information, the energy information, and the task information.

In one optional embodiment, after dynamically allocating the target task to the target node, the method further comprises:
obtaining, through the distributed computing power scheduling platform, characteristic factors for characterizing growth of a computing power demand;
constructing, through the distributed computing power scheduling platform, a prediction model based on the characteristic factors, where the prediction model is configured to predict a computing power demand of a subsequent scheduling period;
obtaining, through the distributed computing power scheduling platform, a matching degree between current energy parameters and historical energy parameters;
generating, through the distributed computing power scheduling platform, first predicted computing power data according to the matching degree and historical computing power data, where the first predicted computing power data comprises the computing power demand of a plurality of future time periods;
obtaining, through the distributed computing power scheduling platform, initial values of the characteristic factors according to the first predicted computing power data, current actual computing power data, and the prediction model; and
predicting, through the distributed computing power scheduling platform, the computing power demand according to the prediction model corresponding to the initial values of the characteristic factors, and using the computing power demand predicted as a basis for updating target node matching in the subsequent scheduling period.

In one optional embodiment, the characteristic factors comprise a first characteristic factor and a second characteristic factor, the first characteristic factor represents a driving effect of energy supply capability on the computing power demand, and the second characteristic factor represents synergistic growth of the computing power demand caused by network effects.

In one optional embodiment, an expression of the prediction model is:

$$\frac{d C ( t )}{d t} = p \cdot ( {E}_{max} - E ( t ) ) + q \cdot E ( t ) \cdot ( 1 - \frac{E ( t )}{{E}_{max}} ) .$$

C(t) is the computing power demand at time t, E(t) is an energy supply capability at time t, Eₘₐₓ is a maximum available energy capacity of the distributed energy system, p is the first characteristic factor, and q is the second characteristic factor.

In one optional embodiment, the obtaining, through the distributed computing power scheduling platform, the initial values of the characteristic factors according to the first predicted computing power data, the current actual computing power data, and the prediction model comprises:
constructing, through the distributed computing power scheduling platform, an intermediate model based on historical energy data;
generating, through the distributed computing power scheduling platform, second predicted computing power data by using the intermediate model;
correcting, through the distributed computing power scheduling platform, the second predicted computing power data according to a deviation between the current actual computing power data and the second predicted computing power data to obtain third predicted computing power data; and
obtaining, through the distributed computing power scheduling platform, the initial values of the characteristic factors according to data of trend nodes in the third predicted computing power data and the prediction model.

In one optional embodiment, the correcting, through the distributed computing power scheduling platform, the second predicted computing power data according to the deviation between the current actual computing power data and the second predicted computing power data to obtain the third predicted computing power data comprises:
obtaining, through the distributed computing power scheduling platform, an average deviation between first data in the second predicted computing power data and the current actual computing power data, where the first data is data in the second predicted computing power data corresponding to the current actual computing power data; and
correcting, through the distributed computing power scheduling platform, the second predicted computing power data according to the average deviation to obtain the third predicted computing power data.

In one optional embodiment, the trend nodes comprise an energy supply saturation time point, a time point where the computing power demand shifts from linear growth to exponential growth, and a critical point where the network effects trigger the synergistic growth of the computing power demand.

In one optional embodiment, the method further comprises: when the distributed computing power scheduling platform detects that an energy supply fluctuation rate exceeds a predetermined threshold, triggering, through the distributed computing power scheduling platform, a dynamic scheduling protocol.

The dynamic scheduling protocol comprises one or more of following processes:
shutting down non-essential high-power-consumption computing nodes,
migrating a to-be-migrated task affected by energy supply fluctuations to a distributed computing node with stable energy supply, and
correcting, by the distributed computing power scheduling platform, a value of the second characteristic factor according to a migration result.

### BRIEF DESCRIPTION OF DRAWINGS

FIG. 1 is a flowchart of a method for scheduling distributed computing power based on distributed energy supply according to one embodiment of the present disclosure.

FIG. 2 is a flowchart of step S400 according to one embodiment of the present disclosure.

FIG. 3 is a flowchart of step S450 according to one embodiment of the present disclosure.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments.

In the specification, terms such as “first” and “second” are only used for the purpose of description, rather than being understood to indicate or imply relative importance or hint the number of indicated technical features. Thus, the feature limited by “first” and “second” can explicitly or implicitly include one or more features. In the description of the present disclosure, the meaning of “a plurality of” is two or more unless otherwise specified.

Furthermore, in the present disclosure, directional terms such as “upper,” “lower,” “left,” and “right” may include, but are not limited to, being defined relative to the orientation in which components are schematically placed in the accompanying drawings. It should be understood that these directional terms may be relative concepts used for relative description and clarification, and may change accordingly based on changes in the orientation in which the components are placed in the drawings.

In the present disclosure, unless otherwise clearly specified and limited, the term “connection” should be understood in a broad sense. For example, a “connection” may be a fixed connection, a detachable connection, or formed as a single integral part. The connection may be a direct connection or an indirect connection through an intermediate medium. Furthermore, the term “electrical connection” may refer to a manner of electrical connection that achieves signal transmission.

As used herein, “about,” “substantially,” or “approximately” includes the stated value as well as a reference value within an acceptable range of deviation for the particular value, where the acceptable range of deviation is determined by one of ordinary skill in the art considering the measurement in question and the error associated with the measurement of a particular quantity (i.e., the limitations of the measurement method).

In the embodiments of the present disclosure, words such as “exemplarily” or “for example” are used to represent an example, instance, or illustration. Any embodiment or design described as “exemplary” or “for example” in the embodiments of the present disclosure should not be interpreted as being more preferred or advantageous than other embodiments or designs. Rather, the use of words such as “exemplarily” or “for example” is intended to present concepts in a concrete manner.

With an acceleration of digitalization, a global demand for computing power has exploded. However, conventional centralized computing power supply models, such as large data centers, face numerous issues. Specifically, the large data centers not only consume enormous amounts of energy and have high construction and operation costs, but also impose stringent requirements on geographical locations and infrastructure. Meanwhile, distributed energy sources, such as renewable energy, including solar, wind, and tidal energy, while widely distributed and environmentally friendly, face challenges in energy storage and consumption due to their intermittent and volatile characteristics. A large amount of distributed energy is wasted during production because the distributed energy is not utilized in a timely manner and effectively. Furthermore, a significant portion of the distributed energy is lost during an inversion process of converting the distributed energy from direct current (DC) to alternating current (AC), resulting in a substantial waste of the distributed energy.

The conventional centralized computing centers face problems such as high energy consumption (which requires AC-to-DC conversion), high construction costs, and geographical restrictions. Concurrently, although the distributed energy, such as the solar energy, wind energy, and small-scale hydro power, is widely distributed across various regions. However, the distributed energy needs to be converted from DC to AC followed by transmission through a power grid. Utilization efficiency of the distributed energy needs further improvement, and there are difficulties in energy utilization. Therefore, how to effectively integrate distributed energy, supply power to distributed computing nodes, and form schedulable computing power resources has become an urgent technical problem to be solved to make up for the insufficiency of conventional centralized computing power.

In the prior art, the centralized computing centers generally rely on centralized power grid supplies, leading to problems such as high energy consumption, high carbon emissions, and high deployment costs in remote areas. Moreover, the distributed energy (e.g., wind energy, photovoltaics) is characterized by intermittent power supply, making it difficult to directly match requirements of high-stability computing power.

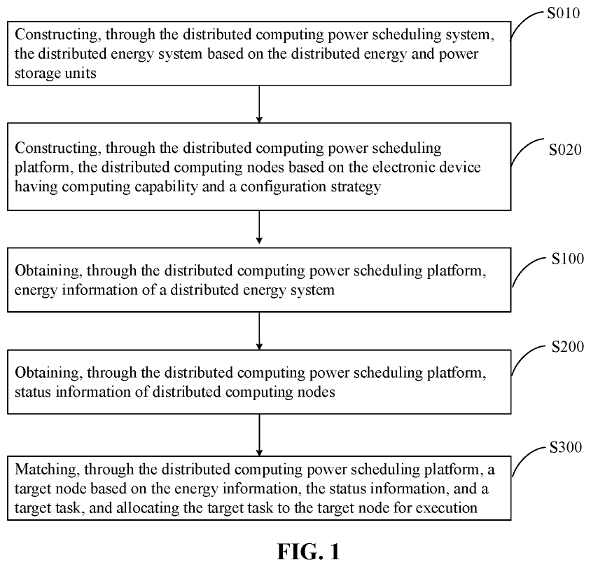

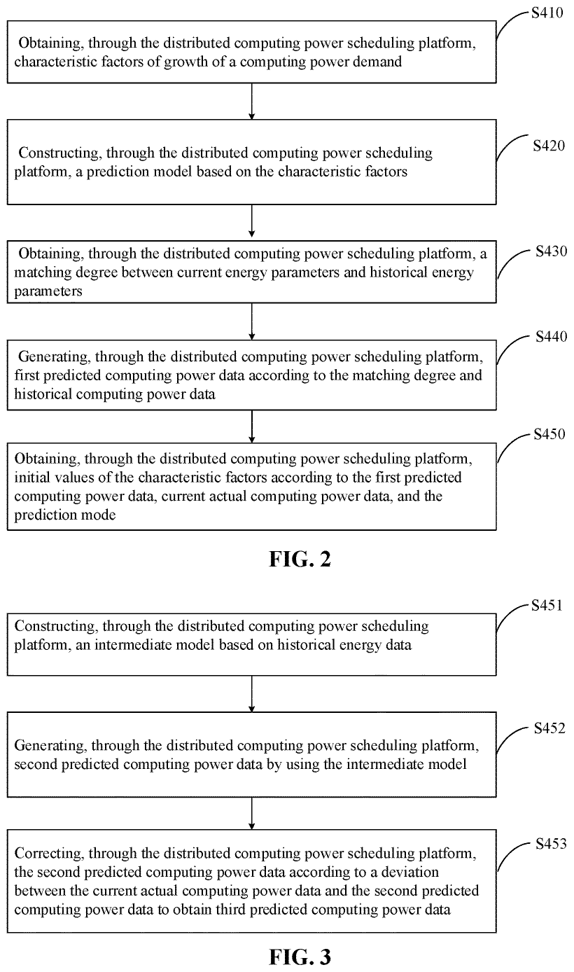

The present disclosure provides a method for scheduling distributed computing power based on distributed energy supply, so as to improve utilization efficiency of the distributed energy, reduce cost of obtaining computing power, and achieve collaborative optimization of the distributed energy and the distributed computing power. As shown in FIGS. 1-3, the method comprises steps S010-S300.

The method is executed by a distributed computing power scheduling system. The distributed computing power scheduling system comprises a distributed computing power scheduling platform, a distributed energy system, and distributed computing nodes. The distributed computing power scheduling platform comprises at least one processor, a memory, and a communication module. The communication module communicates with the distributed energy system and the distributed computing nodes. The at least one processor is configured to execute energy information obtaining, status information obtaining, target node matching, task allocation, and computing power demand prediction.

The step S010 comprises constructing, through the distributed computing power scheduling system, the distributed energy system based on the distributed energy and power storage units. Each of the power storage units comprises at least one of a battery power storage unit and a supercapacitor power storage unit.

For instance, in the embodiment, the distributed energy comprises solar energy and wind energy, and each of the power storage units comprises the battery power storage unit and/or the supercapacitor power storage unit. The solar energy is converted into DC electrical energy through at least one photovoltaic panel, and the wind energy is converted into AC electrical energy through at least one wind turbine. After the DC electrical energy and the AC electrical energy are converted into DC electrical energy through a rectifier, a part of the DC electrical energy is directly supplied to a corresponding computing node, and another part of the DC electrical energy is stored in a corresponding battery power storage unit and a corresponding supercapacitor power storage unit. Each battery power storage unit is configured to store a large amount of electrical energy to satisfy long-term energy demands, and each supercapacitor power storage unit is configured to store a small amount of electrical energy but has characteristics of fast charging and discharging to satisfy high power demands within a short period of time.

The step S020 comprises constructing, through the distributed computing power scheduling platform, the distributed computing nodes based on the electronic device having computing capability and a configuration strategy. The configuration strategy at least comprises assigning an identifier and a permission to each of the distributed computing nodes.

Specifically, the distributed computing nodes are composed of the electronic devices having computing capability. Each of the electronic devices is a server, a personal computer, an industrial control computer, etc. A unique identifier and a unique permission are assigned to each of the distributed computing nodes through the configuration strategy. Each identifier is configured to distinguish a corresponding distributed computing node from the distributed computing nodes. Each permission is configured to control access and operation permissions of a corresponding distributed computing node. For example, a computing node A is assigned with an identifier “Node001” and a “high-level permission,” allowing the computing node A to access and process high-level computing tasks. Similarly, a computing node B is assigned with an identifier “Node002” and a “medium-level permission,” allowing the computing node B to access and process medium-level computing tasks.

The step S100 comprises obtaining, through the distributed computing power scheduling platform, energy information of a distributed energy system. The distributed energy comprises one or more of the solar energy, the wind energy, and water energy, and the energy information comprises energy output information and energy reserve information.

For instance, in the embodiment, the distributed energy comprises solar energy, wind energy, and water energy. For different distributed energy, the distributed energy is collected through different energy collection devices pre-configured in the distributed energy system. Specifically, for solar energy, light energy is converted into the DC electrical energy by installing the at least one photovoltaic panel at positions such as building roofs and open spaces. Output power of the at least one photovoltaic panel is monitored in real time through a power sensor, so as to obtain the energy output information of the solar energy. Meanwhile, the DC electrical energy converted from the solar energy is stored through a corresponding power storage device (such as the corresponding battery power storage unit), and a remaining capacity of the corresponding power storage device is monitored in real time through a battery management system, so as to obtain the energy reserve information. For the wind energy, the wind energy is converted into AC electrical energy by using the at least one wind turbine, and the output power of the at least one wind turbine is monitored in real time through an electric meter, so as to obtain the energy output information of the wind energy. A power storage device for the at least one wind turbine is configured to store the DC electrical energy converted from the wind energy, and the remaining capacity thereof is monitored in real time through the battery management system. For the water energy, at least one water turbine drives a generator to generate electrical energy, and output power of the generator is monitored in real time through a power sensor, so as to obtain the energy output information of the water energy. A power storage device for the generator is further configured to store the DC electrical energy converted from the water energy, and the remaining capacity thereof is also monitored in real time through the battery management system.

It is understood that, after collecting the distributed energy, in order to ensure normal use, the distributed energy collected is further pre-processed by the distributed energy system. The pre-processing comprises at least any one of voltage adjustment, frequency conversion, and rectification filtering to make the distributed energy comply with requirements for subsequent energy storage and use. In addition, it is also convenient to use sensors to monitor operating states and energy output data of the energy collection devices in real time.

In some embodiments, when monitoring the operating states of the energy collection devices, various monitoring manners may be adopted. For example, state data such as temperature, impedance, voltage, and current of each of the energy collection devices are first normalized, and then normalized values are used as gray values thereof. The state data of each of the energy collection devices are filled into a predetermined image area as pixel points according to the gray values thereof to obtain a state image of each of the energy collection devices. Subsequently, the state image of each of the energy collection devices is input into a pre-trained neural network, and a state evaluation value is obtained through a softmax function thereof. When the state evaluation value of each of the energy collection devices is within a preset range, it is determined that an operating state of a corresponding energy collection device is normal, otherwise, the operating state of the corresponding energy collection device is determined to be abnormal. Alternatively, a state matrix is constructed according to the normalized values of each of the energy collection devices, and then a correlation value between a current state matrix and a historical state matrix at the same moment is calculated. When a correlation value is within a predetermined range, the operating state of each of the energy collection devices is determined to be normal; otherwise, the operating state of each of the energy collection devices is determined to be abnormal. Alternatively, an information interaction efficiency between the power storage device and the energy collection device may be calculated to determine the operating state of each of the energy collection devices and a corresponding power storage device. For example, an information exchange frequency, information amount of communication packets, and envelope composition of recorded communication packets of an information exchange interface corresponding to each power storage device and the corresponding energy collection device are calculated. Subsequently, a communication state matrix is constructed according to the information exchange frequency, the information amount, and the envelope composition corresponding to each power storage device and the corresponding energy collection device. Then, a correlation value or a similarity value between each communication state matrix and a standard state matrix is calculated. When the correlation value or the similarity value is within a predetermined range, it is determined that each power storage device and the corresponding energy collection device are normal; otherwise, each power storage device and the corresponding energy collection device are determined to be abnormal. Of course, to achieve monitoring requirements, those skilled in the art may also select other feasible monitoring methods besides the examples described in the present disclosure.

The step 200 comprises obtaining, through the distributed computing power scheduling platform, status information of distributed computing nodes. The distributed computing nodes comprise the electronic devices having computing capability, and the status information comprises a computing capability and a task execution status of the distributed computing nodes.

For instance, the distributed computing nodes comprise the electronic devices having computing capability. Each of the electronic devices is selected from the server, the personal computer, the industrial control computer, etc. A performance monitoring software is installed on each of the distributed computing nodes to obtain computing capability information of each of the distributed computing nodes in real time. The computing capability information of each of the distributed computing nodes comprises central processing unit (CPU) utilization, memory occupancy, and graphics card performance. Meanwhile, task execution status of the distributed computing nodes is obtained in real time, including the number of running tasks, task types, task progress, and the like. For example, for a server computing node, the performance monitoring software thereof displays that the CPU utilization is 60% and the memory occupancy is 70%; and a task management module thereof displays that 5 tasks are running (e.g., including 2 data processing tasks and 3 model training tasks), where one data processing task is 50% completed, two model training tasks are 30% completed, and the other 2 tasks have just started running.

It is understood that, when distributing computing power, hardware upgrading and software adaptation may be performed on the electronic devices first to enable the electronic devices to operate stably when being powered by the distributed energy. Subsequently, the adapted electronic devices are configured as the distributed computing nodes to access a distributed computing power network through a wired or wireless communication network, and the unique identifier and the unique permission are assigned to each of the distributed computing nodes to ensure communication security and smooth data interaction between the distributed computing nodes. Alternatively, computing resources of the electronic devices are integrated into a computing power network capable of unified scheduling through a software-defined manner, so as to achieve efficient application of the computing power.

The step S300 comprises matching, through the distributed computing power scheduling platform, a target node based on the energy information, the status information, and a target task, and allocating the target task to the target node for execution. The target node is one of the distributed computing nodes having a highest matching degree with the target task. The step S300 comprises steps S310-S320.

The step S310 comprises extracting, through the distributed computing power scheduling platform, task information of the target task. The task information at least comprises energy consumption, computational complexity, and time constraints.

For instance, when a user submits a target task, key information of the target task is extracted through a task analysis module. For example, for a deep learning model training task, it is extracted that the estimated energy consumption of the target task is 100 kWh, the computational complexity of the target task is 10\hat{ }12 floating-point operations, and the time constraint of the target task is completion within 48 hours.

The step 320 comprises dynamically allocating, through the distributed computing power scheduling platform, the target task to the target node through a multi-objective scheduling algorithm according to the status information, the energy information, and the task information.

Specifically, according to the status information of the distributed computing nodes (such as the computing capability and the task execution status), the energy information of the distributed energy system (such as the energy output information and the energy reserve information), and the task information of the target task (such as the energy consumption, the computational complexity, and the time constraints), a matching degree between each of the distributed computing nodes and the target task is calculated through the multi-objective scheduling algorithm. The one of the distributed computing nodes having the highest matching degree is configured as the target node. The target task is dynamically allocated to the target node for execution.

For example, the computing capability of the computing node A is 80 TFLOPS, and a current task execution status thereof is relatively light, and the energy reserves thereof are sufficient. The computing capability of the computing node B is 120 TFLOPS, but a current task execution status thereof is relatively busy, and energy reserves thereof are less. The target task requires a computing capability of 100 TFLOPS, an estimated energy consumption thereof is 50 kWh, and a time constraint thereof is completion within 24 hours. Through calculation by the multi-objective scheduling algorithm, the matching degree between the computing node A and the target task is higher than the matching degree between the computing node B and the target task. Therefore, the computing node A is selected as the target node, and the target task is allocated to the computing node A for execution.

In some examples, a calculation method for the matching degree of each parameter is as follows.

A computing capability matching degree is

$${S}_{compute} . {S}_{compute} = min ( \frac{{C}_{n o d e}}{{C}_{t a s k}} , 1 ) \times 100 \% .$$

C_{node} is current available computing power (TFLOPS) of each of the distributed computing nodes. Cₜₐₛₖ is computing power (TFLOPS) of the target task.

An energy reserve matching degree is

$${S}_{energy} . {S}_{energy} = min ( \frac{{E}_{n o d e}}{{E}_{t a s k}} , 1 ) \times 100 \% ,$$

where E_{node} is remaining available energy (kWh) of each of the distributed computing nodes, and Eₜₐₛₖ is the estimated energy consumption (kWh) of the target task.

A task load matching degree is

$${S}_{l o a d} . {S}_{l o a d} = ( 1 - \frac{{T}_{running}}{{T}_{max}} ) \times 100 \% ,$$

where T_{running} is the number of tasks being executed by each of the distributed computing nodes, and Tₘₐₓ is a maximum concurrent task capacity of each of the distributed computing nodes.

A time constraint matching degree is

$${S}_{t i m e} . {S}_{t i m e} = \{ \begin{matrix}100 \% & if {t}_{predicted} \leq {t}_{t a s k} \\ 0 \% & otherwise\end{matrix} ,$$

where t_{predicted} is an estimated time (hours) for each of the distributed computing nodes to complete the task task, and tₜₐₛₖ is the time constraint (hours) of the target task.

A comprehensive matching degree between each of the distributed computing nodes and the target task is obtained through weighted summation:

S_{z}=w₁×S_{compute}+w₂×S_{energy}+w₃×S_{load}+w₄×_{time.}

w1-w4 are weight coefficients, and a sum thereof is 1.

By quantifying matching degrees of the computing capability, the energy reserves, the task load, and the time constraints, and combining with weight allocation, the method is able to accurately select an optimal computing node to ensure efficient task execution and rational energy utilization.

It is understood that calculating a matching degree of each performance parameter of each of the distributed computing modes and a corresponding task parameter of the target task and obtaining a comprehensive matching degree by weighting are conventional technical means for those skilled in the art, which are not limited thereto. Those skilled in the art may, under inspiration of the present disclosure, select a scheduling algorithm for allocating the target task to the target node by themselves.

After completion of the matching of the target node in the current scheduling period, a task execution status and energy consumption of the distributed computing nodes form new status information. To avoid disconnection between the step of allocating the target task and subsequent prediction steps, the present disclosure uses the following prediction results of the computing power demand as a basis for updating task allocation, node migration, and characteristic factor correction in subsequent scheduling periods.

Computing power demand prediction technology is an important part of distributed energy management, and a purpose thereof is to predict development trends of computing power demand by analyzing historical data and energy factors, so as to provide a scientific basis for rational allocation of computing power resources. Current computing power demand prediction methods mainly comprise empirical prediction, statistical model prediction, machine learning prediction, etc.

Although current computing power demand prediction technologies are able to provide references for distributed energy management to some extent, the current computing power demand prediction technologies generally have deficiencies, resulting in a problem of poor prediction effects of the computing power demand. For example, current prediction models are generally based on simple extrapolation of historical data, resulting in a large deviation between prediction results and actual situations. Moreover, many prediction models highly depend on accumulation of a large amount of historical data, and for regions where data collection is incomplete or historical data is lacking, applicability and accuracy of such prediction models are limited. In addition, the growth of computing power demand is affected by various factors such as energy supply capability and network effects, and the current prediction models are generally difficult to accurately simulate dynamic impacts of these factors on the computing power demand.

Therefore, prediction methods in the prior art have poor prediction effects on the computing power demand. The method in the embodiments of the present disclosure further comprises the following steps S410-S450 to solve a problem that the current prediction methods in the prior art have poor prediction effects on the computing power demand.

The step S410 comprises obtaining, through the distributed computing power scheduling platform, characteristic factors of growth of the computing power demand. The characteristic factors comprise a first characteristic factor and a second characteristic factor. The first characteristic factor represents a driving effect of energy supply capability on the computing power demand. The second characteristic factor represents synergistic growth of the computing power demand caused by network effects.

The growth of the computing power demand is affected by different factors, among which the most critical one are the energy supply capability and the network effects. The energy supply capability determines an upper limit of the computing power resources, while the network effects affect the synergistic growth of the computing power demand.

The energy supply capability is the foundation for the growth of the computing power demand. An improvement in the energy supply capability supports an operation of more computing power devices, thereby directly driving the growth of the computing power demand. For example, an increase in power generation of the distributed energy and an improvement in the remaining capacity of the power storage systems are able to enhance the energy supply capability, thereby promoting the growth of the computing power demand.

The network effects refer to the mutual influence and synergistic growth of the computing power demand among users. As more and more users access the computing power network, the computing power resources and service quality available to each user improve, thereby attracting more users to join and forming the synergistic growth of the computing power demand. For example, an increase in the number of users of a cloud computing platform may drive an overall improvement in the computing power demand of the cloud computing platform. An improvement in task collaboration efficiency between the distributed computing nodes may also lead to a positive feedback effect of the growth in the computing power demand.

Therefore, the present disclosure takes the driving effect of the energy supply capability on the computing power demand as the first characteristic factor, and takes the synergistic growth of the computing power demand caused by the network effects as the second characteristic factor. The first characteristic factor and the second characteristic factor jointly determine a growth trend of the computing power demand.

The step S420 comprises constructing, through the distributed computing power scheduling platform, a prediction model based on the characteristic factors. The prediction model is configured to predict a computing power demand.

Specifically, the prediction model is constructed based on the characteristic factors extracted. An expression of the prediction model is:

$$\frac{d C ( t )}{d t} = p \cdot ( {E}_{max} - E ( t ) ) + q \cdot E ( t ) \cdot ( 1 - \frac{E ( t )}{{E}_{max}} ) .$$

The prediction model takes into account both the impact of energy supply capacity and network effects on the computing power demand. C(t) is a computing power demand at time t (TFLOPS/hour), E(t) is an energy supply capability at time t, Eₘₐₓ is a maximum available energy capacity of the distributed energy system, p is the first characteristic factor, and q is the second characteristic factor. The first characteristic factor p represents the driving effect of the energy supply capability on the computing power demand. The second characteristic factor q represents the synergistic growth of the computing power demand caused by network effects.

The prediction model describes the dynamic change of the computing power demand over time, and a contributions of the energy supply capability and the network effects to the growth of the computing power demand. Specifically, a first term p·(Eₘₐₓ−E(t)) describes the driving effect of the energy supply capability on the computing power demand. As the energy supply capability improves, an unused energy capacity (Eₘₐₓ−E(t)) decreases, and a growth rate of the computing power demand changes accordingly. A second term

$$q \cdot E ( t ) \cdot ( 1 - \frac{E ( t )}{{E}_{max}} )$$

describes the synergistic growth of the computing power demand caused by the network effects. As the energy supply capability improves, the network effects gradually emerge, and the growth rate of the computing power demand is affected by the network effects. Meanwhile, the prediction model regards the growth of the computing power demand as a dynamic system jointly affected by the energy supply capability and the network effects, and is able to accurately capture non-linear characteristics of the computing power demand, reflecting complex relationships in the growth of the computing power demand.

The step S430 comprises obtaining, through the distributed computing power scheduling platform, a matching degree between current energy parameters and historical energy parameters. Energy parameters comprise a power generation of the distributed energy, a remaining capacity of the power storage system, an energy fluctuation rate, etc. Changes in the energy parameters directly affect the energy supply capability, thereby affecting the growth of the computing power demand.

Specifically, by deploying the sensors and monitoring devices in the distributed energy system, the energy parameters such as the power generation of the distributed energy, the remaining capacity of the power storage system, and the energy fluctuation rate are obtained in real time. For example, the power generation of the solar energy is obtained through a power sensor on the at least one photovoltaic panel, the remaining capacity of the power storage system is obtained through the management system of power storage batteries, and the energy fluctuation rate is calculated through a data analysis software. The current energy parameters are compared with the historical energy parameters, and similarity between the current energy parameters and the historical energy parameters is quantified through a Pearson correlation coefficient to generate a matching degree score. For example, a Pearson correlation coefficient between a current solar power generation curve and a daily solar power generation curve within the past week is calculated to obtain the matching degree score, so as to evaluate a similarity degree between a current energy condition and historical energy conditions, where a higher matching degree score indicates a higher similarity between the current energy parameters and the historical energy parameters.

Specifically, in some embodiments, a calculation formula is:

$$ρ = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2} {\sum }_{i = 1}^{n} {( {y}_{i} - \overline{y} )}^{2}}} .$$

xᵢ and yᵢ are respectively an i-th data point of the current energy parameters and an i-th data point of the historical energy parameters. x̅ and y̅ are respectively an average value of the current energy parameters and an average value of the historical energy parameters. ρ is the similarity.

The step 440 comprises generating, through the distributed computing power scheduling platform, first predicted computing power data according to the matching degree and historical computing power data. The first predicted computing power data comprises computing power demand of a plurality of future time periods.

Specifically, according to the matching degree between the current energy parameters and the historical energy parameters, combined with the historical computing power data, the first predicted computing power data is generated through a weighted average method or other suitable prediction methods. The first predicted computing power data is configured to predict the computing power demand of the plurality of future time periods. For example, when the matching degree between the current energy parameters and the historical energy parameters is 80%, combined with historical computing power demand data of corresponding time periods within the past week, the first predicted computing power data is generated through the weighted average method to predict a computing power demand of each hour within the next 24 hours. Alternatively, computing power data corresponding to the historical energy parameters having a highest matching degree with the current energy parameters are directly selected as reference data according to the matching degree score. The computing power demand in the reference data is configured as the first predicted computing power data. It is understood that the first predicted computing power data comprises the computing power demand of the plurality of future time periods, and is configured to preliminarily predict a computing power demand trend under a current situation.

The step 450 comprises obtaining, through the distributed computing power scheduling platform, initial values of the characteristic factors according to the first predicted computing power data, current actual computing power data, and the prediction model. The step S450 comprises steps S451-S453.

The step 451 comprises constructing, through the distributed computing power scheduling platform, an intermediate model based on historical energy data.

Specifically, the intermediate model for predicting the computing power demand is constructed by using the historical energy data through time series analysis or other suitable modeling methods. For example, according to the historical energy data of the past year, an autoregressive integrated moving average (ARIMA) model is adopted to construct the intermediate model to predict a trend of the computing power demand in a future time period. In other examples, the intermediate model may be composed of a plurality of prediction models through weighting, such as a Back Propagation (BP) neural network model, a fuzzy neural network model, and an adaptive probabilistic neural network model. Weights of the prediction models are determined according to accuracy of prediction results thereof, where a higher accuracy leads to a larger weight.

The step S452 comprises generating, through the distributed computing power scheduling platform, second predicted computing power data by using the intermediate model.

Specifically, current energy data is input into the intermediate model to generate the second predicted computing power data. For example, current solar power generation data is input into the intermediate model to obtain predicted data of a computing power demand of each hour within the future 24 hours.

The step S453 comprises correcting, through the distributed computing power scheduling platform, the second predicted computing power data according to a deviation between the current actual computing power data and the second predicted computing power data to obtain third predicted computing power data. The step S453 comprises steps S4531 and S4532.

The step S4531 comprises obtaining, through the distributed computing power scheduling platform, an average deviation between first data in the second predicted computing power data and the current actual computing power data. The first data is data in the second predicted computing power data corresponding to the current actual computing power data.

Specifically, data corresponding to the current actual computing power data is selected from the second predicted computing power data, and the average deviation between the first data and the current actual computing power data is calculated. For example, data of each hour within the past 24 hours in the second predicted computing power data is selected and compared with the current actual computing power data, so as to calculate and obtain the average deviation of 8 TFLOPS/hour.

The step S4532 comprises correcting, through the distributed computing power scheduling platform, the second predicted computing power data according to the average deviation to obtain the third predicted computing power data.

Specifically, according to the average deviation, a weighting algorithm is adopted to perform dynamic compensation on the second predicted computing power data to generate the third predicted computing power data. For example, according to the average deviation of 8 TFLOPS/hour, the second predicted computing power data is compensated through the weighting algorithm to obtain the third predicted computing power data, so as to improve prediction accuracy. In some examples, the third predicted computing power data is calculated by using the following formula:

C_{corrected}(t)=C_{predicted}(t)+α·deviation.

C_{corrected}(t) is a corrected computing power demand (i.e., the third predicted computing power data), C_{predicted}(t) is the second predicted computing power data, α is a weighting coefficient determined by those skilled in the art according to requirements, which may be 0-1 (such as 1) in the embodiment, and deviation is the average deviation between the second predicted computing power data and the current actual computing power data.

The step S454 comprises obtaining, through the distributed computing power scheduling platform, the initial values of the characteristic factors according to data of trend nodes in the third predicted computing power data and the prediction model.

Specifically, the trend nodes comprise an energy supply saturation time point, a time point where the computing power demand shifts from linear growth to exponential growth, and a critical point where the network effects trigger the synergistic growth of the computing power demand.

The energy supply saturation time point refers to a time point where the energy supply reaches a maximum value. The time point where the computing power demand shifts from linear growth to exponential growth refers to a time point where a growth rate of the computing power demand changes from linear growth to exponential growth. The critical point where the network effects trigger the synergistic growth of the computing power demand refers to a time point where the network effects start to significantly affect the growth of the computing power demand.

The data of the trend nodes are substituted into the prediction model to solve for the initial values of the characteristic factors. For example, energy supply inflection point data and computing power demand peak data in the third predicted computing power data are extracted and substituted into the prediction model to calculate and obtain the initial values of the characteristic factors.

The step 460 comprises predicting, through the distributed computing power scheduling platform, the computing power demand according to the prediction model corresponding to the initial values of the characteristic factors.

Specifically, the obtained initial values of the characteristic factors are substituted into the prediction model to predict the computing power demand in the future time period. For example, the initial values of the characteristic factors (such as p=0.6 and q=0.4) are substituted into the prediction model to predict the computing power demand of each day within the future 7 days, providing a basis for scheduling and allocation of the computing power resources.

The step S500 comprises triggering a dynamic scheduling protocol when the distributed computing power scheduling platform detects that an energy supply fluctuation rate exceeds a predetermined threshold.

Specifically, the monitoring system comprises a power sensor configured to collect power generation output of the distributed energy, a battery management system configured to collect a remaining capacity of the power storage system, node performance monitoring software configured to collect energy consumption and a task status of the computing nodes, and a data analysis module configured to calculate the energy supply fluctuation rate. The monitoring system monitors the energy supply fluctuation rate in real time and sends the energy supply fluctuation rate to the distributed computing power scheduling platform. When the energy supply fluctuation rate exceeds a predetermined threshold, the distributed computing power scheduling platform triggers the dynamic scheduling protocol. For example, when it is detected that a wind power generation fluctuation rate exceeds 30%, the distributed computing power scheduling platform triggers the dynamic scheduling protocol.

For instance, non-essential high-power-consumption computing nodes are shut down according to task importance and power consumption conditions of the distributed computing nodes, so as to reduce overall power consumption and ensure normal operation of critical tasks. For example, a high-power-consumption computing node performing a non-urgent task, such as a computing node performing a low-priority data analysis task, is shut down.

For instance, any to-be-migrated task originally executed on the high-power-consumption computing node is migrated, according to characteristics and requirements of the to-be-migrated task, to a corresponding distributed computing node with the stable energy supply to continue execution, so as to ensure continuity and stability of the to-be-migrated task. For example, an artificial intelligence training task in progress is migrated from a computing node affected by energy fluctuations to another computing node with a stable energy supply.

For instance, according to a distribution and a task execution status of the distributed computing nodes after migration of the to-be-migrated task, the synergistic growth of the computing power demand caused by the network effects is re-evaluated, and the value of the second characteristic factor (a network effect coefficient) is corrected. For example, after the task migration, cooperation modes among the distributed computing nodes change, and by analyzing a new task distribution and cooperation frequencies, and according to a change in the computing power demand after the migration of the to-be-migrated task, a new network effect coefficient is calculated and substituted into the prediction model, thereby improving accuracy of the prediction model.

In summary, the present disclosure can achieve at least one or more of following beneficial effects:

The present disclosure improves energy utilization efficiency. The present disclosure efficiently supplies distributed green energy, such as solar energy, wind energy, and tidal energy, which was originally difficult to utilize effectively, to the electronic devices having computing capability and forms the schedulable computing power resources, thereby reducing energy waste, maximizing utilization of benefits, and improving comprehensive utilization efficiency of the distributed green energy.

The present disclosure can reduce computing power costs. Low cost is a basic requirement for the popularization of artificial intelligence technology. The distributed computing power network is established by using the distributed energy and the electronic devices, avoiding various high costs of large-scale construction and operation of centralized data centers. Such distributed computing power equipment (i.e., the distributed computing nodes obtaining great benefits with small capital investment) is easier to deploy, solving the problem of one-time large investment in construction of the centralized data centers through distributed computing power construction and lowering the predetermined threshold for obtaining the computing power.

The present disclosure enhances system flexibility and stability. The distributed energy and a computing power architecture enable the distributed energy system to perform flexible adjustment according to changes in energy and demand, enhancing anti-risk capability and stability of the distributed energy system.

The present disclosure promotes integrated development of energy and information technology. The present disclosure provides a new computing power approach and method for deep integration of the energy field and the information technology field, improves the utilization efficiency of distributed green energy, and makes up for the deficiency of centralized computing power resources.

Through the description of the above embodiments, those skilled in the art may clearly understand that the method in the above-described embodiments may be implemented by means of software and a necessary universal hardware platform, or certainly may be implemented by hardware. However, in many cases, the means of software and the necessary universal hardware platform are a preferred embodiment. Based on such understanding, the technical solutions of the present disclosure essentially, or the part contributing to the related art, may be embodied in a form of a software product. The software product is stored on a storage medium (such as a ROM/RAM, a magnetic disk, or an optical disk) and includes instructions for causing a terminal device (which may be a mobile phone, a computer, a server, a network device, etc.) to execute the method described in the various embodiments of the present disclosure.

Through the description of the above embodiments, those skilled in the art may clearly understand that, for convenience and conciseness of description, the division of functional modules described above is only used as an example for illustration. In practical applications, these functions may be allocated to different functional modules as required. That is, an internal structure of an apparatus is divided into different functional modules to accomplish all or part of the functions described above.

In the embodiments provided in the present disclosure, it should be understood that the disclosed device and method may be implemented in other manners. For example, the device embodiments described above are merely exemplary. For example, the division of modules or units is merely a logical function division, and there may be other division methods during actual implementation. For example, multiple units or components may be combined or integrated into another apparatus, or some features may be ignored or not executed. In addition, the displayed or discussed mutual coupling, direct coupling, or communication connection may be indirect coupling or communication connection through some interfaces, apparatuses, or units, and may be in electrical, mechanical, or other forms.

The units described as separate components may or may not be physically separate, and the components displayed as units may be one physical unit or multiple physical units. That is, the units may be located in one place or distributed across multiple different places. Part or all of the units may be selected according to actual needs to achieve the objectives of the solutions of the present embodiments.

Furthermore, individual functional units in the various embodiments of the present disclosure may be integrated into one processing unit, or each unit may exist physically independently, or two or more units may be integrated into one unit. The above-integrated units may be implemented in the form of hardware.

The above are only optional embodiments of the present disclosure, but the protection scope of the present disclosure is not limited thereto. Any changes or substitutions that can be easily conceived by those skilled in the art within the technical scope disclosed in the present disclosure shall fall within the protection scope of the present disclosure. Therefore, the protection scope of the present disclosure should be determined by the protection scope of the claims.

What is claimed is:

1. A method for scheduling distributed computing power based on distributed energy supply, comprising:
obtaining, through the distributed computing power scheduling platform, energy information of a distributed energy system, wherein the distributed energy comprises one or more of solar energy, wind energy, and water energy, and the energy information comprises energy output information and energy reserve information;
obtaining, through the distributed computing power scheduling platform, status information of distributed computing nodes, wherein each of the distributed computing nodes comprises an electronic device having computing capability, and the status information comprises a computing capability and a task execution status of each of the distributed computing nodes; and
matching, through the distributed computing power scheduling platform, a target node based on the energy information, the status information, and a target task, and allocating the target task to the target node for execution, wherein the target node is one of the distributed computing nodes having a highest matching degree with the target task within a current scheduling period;
wherein the method is executed by a distributed computing power scheduling system, the distributed computing power scheduling system comprises the distributed computing power scheduling platform, the distributed energy system, and the distributed computing nodes, and the distributed computing power scheduling platform is communicated with the distributed energy system and the distributed computing nodes;
wherein before obtaining, through the distributed computing power scheduling platform, the energy information of the distributed energy system, the method further comprises:
constructing, by the distributed computing power scheduling system, the distributed energy system based on the distributed energy and power storage units, wherein each of the power storage units comprises at least one of a battery power storage unit and a supercapacitor power storage unit; and
constructing, through the distributed computing power scheduling platform, the distributed computing nodes based on the electronic device having computing capability and a configuration strategy, wherein the configuration strategy at least comprises assigning an identifier and a permission to each of the distributed computing nodes;
wherein the matching, through the distributed computing power scheduling platform, the target node based on the energy information, the status information, and the target task comprises:
extracting, through the distributed computing power scheduling platform, task information of the target task, wherein the task information at least comprises energy consumption, computational complexity, and time constraints; and
dynamically allocating, through the distributed computing power scheduling platform, the target task to the target node through a multi-objective scheduling algorithm according to the status information, the energy information, and the task information;
wherein after dynamically allocating the target task to the target node, the method further comprises:
obtaining, through the distributed computing power scheduling platform, characteristic factors for characterizing growth of a computing power demand;
constructing, through the distributed computing power scheduling platform, a prediction model based on the characteristic factors, wherein the prediction model is configured to predict a computing power demand of a subsequent scheduling period;
wherein an expression of the prediction model is:
$$\frac{d C ( t )}{d t} = p \cdot ( {E}_{max} - E ( t ) ) + q \cdot E ( t ) \cdot ( 1 - \frac{E ( t )}{{E}_{max}} ) ;$$
wherein C(t) is the computing power demand at time t, E(t) is an energy supply capability at time t, Eₘₐₓ is a maximum available energy capacity of the distributed energy system, p is a first characteristic factor, and q is a second characteristic factor.

2. The method according to claim 1, wherein before obtaining, through the distributed computing power scheduling platform, the energy information of the distributed energy system, the method further comprises:
collecting the distributed energy through energy collection devices pre-configured in the distributed energy system; and
pre-processing, by the distributed energy system, the distributed energy collected, wherein the pre-processing comprises at least one of voltage adjustment, frequency conversion, and rectification filtering.

3. The method according to claim 1, wherein the method further comprises:
obtaining, through the distributed computing power scheduling platform, a matching degree between current energy parameters and historical energy parameters;
generating, through the distributed computing power scheduling platform, first predicted computing power data according to the matching degree and historical computing power data, wherein the first predicted computing power data comprises the computing power demand of a plurality of future time periods;
obtaining, through the distributed computing power scheduling platform, initial values of the characteristic factors according to the first predicted computing power data, current actual computing power data, and the prediction model; and
predicting, through the distributed computing power scheduling platform, the computing power demand according to the prediction model corresponding to the initial values of the characteristic factors, and using the computing power demand predicted as a basis for updating target node matching in the subsequent scheduling period.

4. The method according to claim 3, wherein the characteristic factors comprise the first characteristic factor and the second characteristic factor, the first characteristic factor represents a driving effect of energy supply capability on the computing power demand, and the second characteristic factor represents synergistic growth of the computing power demand caused by network effects.

5. The method according to claim 3, wherein the obtaining, through the distributed computing power scheduling platform, the initial values of the characteristic factors according to the first predicted computing power data, the current actual computing power data, and the prediction model comprises:
constructing, through the distributed computing power scheduling platform, an intermediate model based on historical energy data;
generating, through the distributed computing power scheduling platform, second predicted computing power data by using the intermediate model;
correcting, through the distributed computing power scheduling platform, the second predicted computing power data according to a deviation between the current actual computing power data and the second predicted computing power data to obtain third predicted computing power data; and
obtaining, through the distributed computing power scheduling platform, the initial values of the characteristic factors according to data of trend nodes in the third predicted computing power data and the prediction model.

6. The method according to claim 5, wherein the correcting, through the distributed computing power scheduling platform, the second predicted computing power data according to the deviation between the current actual computing power data and the second predicted computing power data to obtain the third predicted computing power data comprises:
obtaining, through the distributed computing power scheduling platform, an average deviation between first data in the second predicted computing power data and the current actual computing power data, wherein the first data is data in the second predicted computing power data corresponding to the current actual computing power data; and
correcting, through the distributed computing power scheduling platform, the second predicted computing power data according to the average deviation to obtain the third predicted computing power data.

7. The method according to claim 5, wherein the trend nodes comprise an energy supply saturation time point, a time point where the computing power demand shifts from linear growth to exponential growth, and a critical point where the network effects trigger the synergistic growth of the computing power demand.
